(19) United States
(12) Patent Application Publication
(10) Pub. No.: US 2005/0051223 A1
(43) Pub. Date: Mar. 10, 2005

(54) Tubular diaphragm tank

(76) Inventors: Robert Lombari, North Smithfield, RI (US); Wei-Chiao Lo, Taichung (TW)

Correspondence Address: Choate, Hall & Stewart, Exchange Place, 53 State Street, Boston, MA, 02109, US

(21) Appl. No.: 10/658,705

(22) Filed: Sep. 9, 2003

(51) Int. Cl. F16L 55/04

(52) U.S. Cl. 138/30; 138/26

(57) ABSTRACT

A tubular expansion tank. Fluid may pass into and displace a diaphragm disposed outside of a pipe within the tank if the fluid pressure is greater than a tank pressure pushing the diaphragm against the pipe. When the fluid pressure decreases, the fluid passes from the diaphragm back into the pipe and out of the tank.

### FIELD OF THE INVENTION

The invention pertains to a diaphragm tank, and more specifically, to a tubular diaphragm tank having robust construction.

### BACKGROUND OF THE INVENTION

There are many settings within water delivery systems in which the amount of water that must be contained varies over time. For example, water expands when heated. In a closed system, this expansion may cause dangerous increases in water pressure. While any water heating system has relief valves to vent excess pressure and prevent damage to the water heater and surrounding piping, it is undesirable to have hot water venting in a residential setting. As a result, expansion tanks are used to absorb the excess pressure and release water back into the water heater when the pressure decreases.

### SUMMARY OF THE INVENTION

In one aspect, the invention is a tubular expansion tank. The tank includes a pressure assembly having a passage fitting providing fluidic communication between an interior and an exterior at the pressure assembly and a water chamber assembly. The water chamber assembly includes a tube having at least one notch at one end, a cylindrical diaphragm disposed about the tube such that the notch provides fluidic communication between an interior of the tube and an interior of the diaphragm, and a collar providing fluidic communication between the passage fitting and the interior of the tube. One end of the diaphragm is sealingly fitted to a portion of the collar.

The expansion tank may further include a valve providing controllable fluidic communication between an exterior of the tank and a space between the pressure assembly and the diaphragm. The pressure assembly may be metallic and include first and second domes sealingly affixed to one another. The passage fitting would then be disposed in one of the domes. A portion of the collar may have an outer diameter that is approximately equal to an inner diameter of the diaphragm. The first end of the tube may have a plurality of notches. The water chamber assembly may include a cap disposed at the second end of the tube. A second end of the diaphragm is sealingly fitted to the cap. The cap may be sealingly attached to the second end of the tube. The tank may be adapted and constructed such that at least a middle portion of the diaphragm is configured to contact the tube at normal operating pressures.

In another aspect, the invention is a tubular expansion tank. The tank includes a metallic pressure assembly including first and second domes joined by a welded joint to form a chamber and a fitting attached to the first dome and adapted and constructed for connection to a plumbing system and providing fluidic communication between an interior and an exterior of the pressure assembly. The tank further includes a water chamber assembly including a tube having first and second ends and a cylindrical diaphragm disposed about the tube. An interior of the diaphragm is in fluidic communication with the interior of the tube. The water chamber assembly further includes a collar providing fluidic communication between the fitting and the interior of the tube. A first end of the diaphragm is sealingly affixed to a portion of the collar.

In another aspect, the invention is a pre-assembled water chamber assembly for an expansion tank. The water chamber assembly includes a tube having first and second ends, a collar disposed at the first end of the tube, a cap disposed at the second end of the tube, and a resilient diaphragm having first and second ends. The first end of the diaphragm is sealingly fitted about the collar, and the second end of the diaphragm is sealingly fitted about the cap. The collar may include two portions having different exterior diameters. The exterior diameter of one of the portions is the same as the exterior diameter of the cap.

### BRIEF DESCRIPTION OF THE DRAWING

The invention is described with reference to the several figures of the drawing, in which,

FIG. 1 is a schematic diagram of a tubular diaphragm tank according to an embodiment of the invention;

FIG. 2 is an exploded view of the diaphragm tank illustrated in FIG. 1; and

FIG. 3 is a schematic diagram of portion of an exemplary heating system including a boiler and diaphragm tank according to an embodiment of the invention.

### DETAILED DESCRIPTION OF CERTAIN PREFERRED EMBODIMENTS

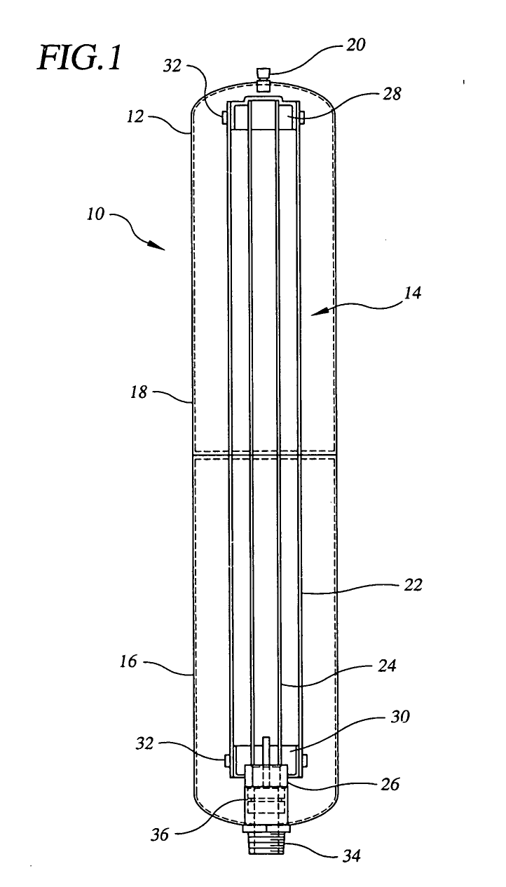

FIG. 1 illustrates a tubular diaphragm tank 10 according to an embodiment of the invention. The tank 10 includes an external case, for example, pressure assembly 12, and a water assembly, for example, water chamber assembly 14, in which water is held while it is in the tank 10. The pressure assembly 12 includes inlet dome 16 and venting dome 18. Domes 16 and 18 may be attached, for example, through welding, to one another to form pressure assembly 12.

One skilled in the art will recognize that inlet dome 16 and venting dome 18 may take on any shape so long as they may be attached to one another. For example, the domes 16 may be cup-shaped, as shown, or flat caps with squared or rounded corners, or some other shape.

It is preferable that the domes not flex significantly as the pressure within pressure assembly 12 changes. This will depend on the thickness of the walls and the pressure within the assembly. One skilled in the art may easily determine the required thickness for the expected pressures within tank 10.

As shown in FIG. 1, venting dome 18 is fitted with a valve body 20 through which the interior of pressure assembly 12 may be charged with air or vented. One skilled in the art will recognize that the valve body 20 may also be disposed in a different portion of venting dome 18 or in inlet dome 16.

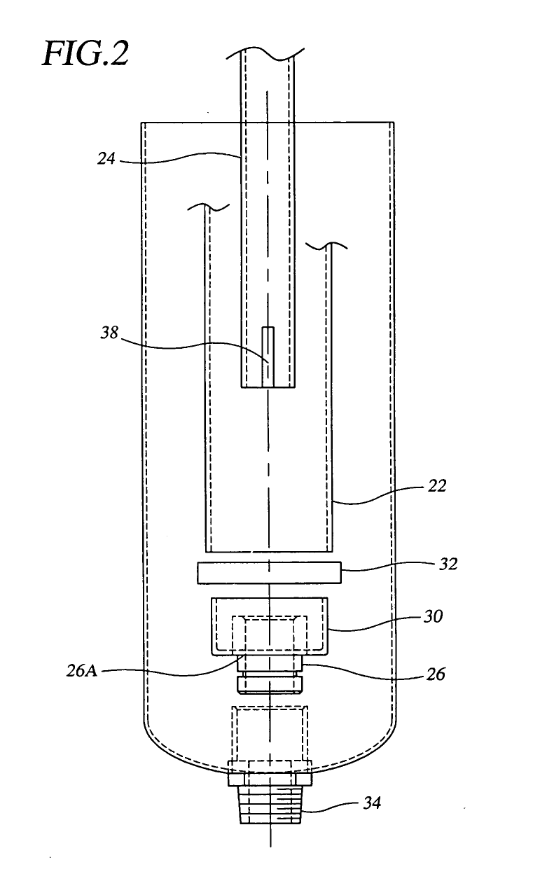

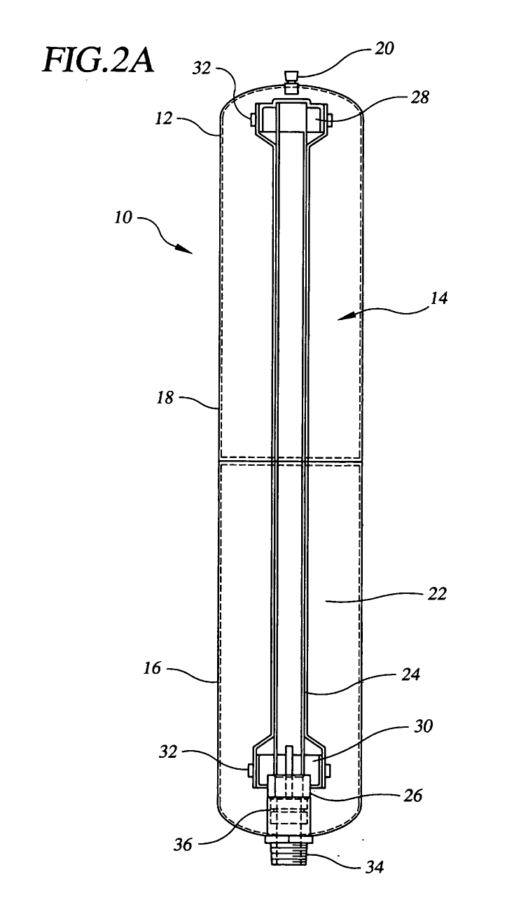

An exploded version of a portion of tank 10 is shown in FIG. 2, showing the components of water chamber assembly 14. One end of tube 24 is inserted into collar 26. In one embodiment, collar 26 has a shoulder 26A to limit lateral motion of tube 24 within the collar 26. Diaphragm 22 fits around the outside of retainer 30 and cap 28 and is retained in place by clamps 32. The diaphragm 22 retains cap 28 against the far end of tube 24 (FIG. 1) As a result, water may still pass out of the tube 24, along the inside of the cap and into the space between diaphragm 6 and tube 24. Alternatively, cap 28 may be affixed, for example, by welding, to the end of tube 24. Clamps 32 also prevent water leakage from water chamber assembly 14 to the space between the diaphragm 22 and pressure assembly 12. One skilled in the art will recognize that retainer 30 and collar 26 may be formed as a monolithic piece or separately and then attached to one another.

In one embodiment, tank 10 is assembled by connecting water chamber assembly 12 to inlet dome 16 by inserting collar 26 into fitting 34. O-ring 36 in a groove in collar 26 prevents leakage of water from fitting 34 to the space between diaphragm 22 and pressure assembly 12. In one embodiment, fitting 34 is already attached to inlet dome 16. For example, the assembly of fitting 34 and inlet dome 16 may be assembled as a monolithic piece. Alternatively, fitting 34 may be welded to inlet dome 16. Venting dome 18 is then sealingly secured to inlet dome 16, preferably by welding, to form pressure assembly 12.

Welding techniques such as metal-inert gas (MIG) and tungsten-inert gas (TIG) may be used to join the domes to each other. Those skilled in the art will recognize that a variety of welding techniques may be used to join the various parts of pressure assembly 12. Because the joints are welded, an increase in pressure within the space between diaphragm 22 and pressure assembly 12 will not force the various parts of pressure assembly 12 to separate from one another.

At normal operating pressures, that is, when the pressure of water flowing past the tank is less than or equal to the precharge pressure within the tank (the pressure of the air between the pressure assembly and the diaphragm when there is a no water in the tank) the space between pressure assembly 12 and diaphragm 22 is pressurized so that the diaphragm is pushed against the outer wall of tube 24. If the water pressure within the tube 24 exceeds the pressure between diaphragm 22 and pressure assembly 12, then water will flow into the tank through fitting 34 and into the space between tube 24 and diaphragm 22 through slots 38 cut into the ends of tube 24. In one embodiment, the end of tube 24 includes two slots 38, offset by 180 degrees. One skilled in the art will realize that more slots may be included if desired. For example, four slots with an offset of 90 degrees or three slots with an offset of 120 degrees may be included. When the water pressure within tube 24 decreases, the diaphragm 22 is forced back against the outside of tube 24, pushing the water back into the tube from the space between tube 24 and diaphragm 22 through the slots 38.

### EXAMPLE 1

### Forced Hot Water Heating

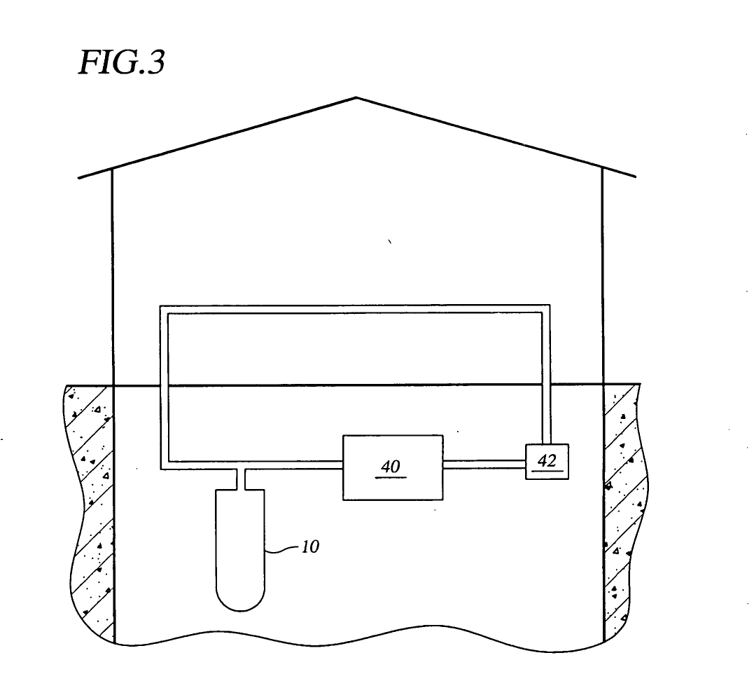

The tank 10 absorbs the increase in pressure from thermal expansion as water is heated in a boiler 40 (FIG. 3) for circulation through a forced hot water heating system. As water is heated in boiler 40, it expands. If circulator 42 is off, then the expanding water increases the pressure upstream of the circulator 42. While hot water heating systems have pressure relief valves to vent water and prevent damage to the boiler, a homeowner, for example, is not likely to appreciate the safety advantages of having hot water venting out of the boiler 40 into the rest of the home. To relieve the pressure, tank 10 is disposed upstream of boiler 40. As water heats up, its expansion increases the upstream water pressure, and the diaphragm expands. When the circulator 42 is on, water from the tank 10 leaves the diaphragm and is circulated through the heating system.

One skilled in the art will recognize that the appropriate tank volume will depend on the capacity of the boiler, the diameter of the piping, and the total capacity of the heating system. Typically, the precharged pressure of the tank, that is, the pressure between the uninflated diaphragm and the pressure assembly 12, is the same as the supply pressure for the system. For example, a 100 kbtu boiler may be used in combination with a 18 liter tank charged to 12 psi. The operating pressure for a boiler for a hot water heating/radiator system is typically between 10 and 30 psi.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

1. A tubular expansion tank, comprising:
a pressure assembly having a passage fitting providing fluidic communication between an interior and an exterior of the pressure assembly; and
a water chamber assembly comprising:
a tube having first and second ends, wherein the first end has at least one slot open to the first end of the tube;
a cylindrical diaphragm disposed about the tube, wherein the slot provides fluidic communication between an interior of the tube and an interior of the diaphragm; and
a collar providing fluidic communication between the passage fitting and the interior of the tube, wherein a first end of the diaphragm is sealingly fitted to a portion of the collar.

2. The tubular expansion tank of claim 1, further comprising a valve providing controllable fluidic communication between an exterior of the tank and a space between the pressure assembly and the diaphragm.

3. The tubular expansion tank of claim 1, wherein the pressure assembly is metallic and comprises first and second domes sealingly affixed to one another, wherein the passage fitting is disposed in one of the first and second domes.

4. The tubular expansion tank of claim 1, wherein a portion of the collar has an outer diameter that is approximately equal to an inner diameter of the diaphragm.

5. The tubular expansion tank of claim 1, wherein the first end of the tube has a plurality of slots.

6. The tubular expansion tank of claim 1, wherein the water chamber assembly further comprises a cap disposed at the second end of the tube to which a second end of the diaphragm is sealingly fitted.

7. The tubular expansion tank of claim 6, wherein the cap is sealingly attached to the second end of the tube.

8. The tubular expansion tank of claim 1, wherein the tank is adapted and constructed such that at least a middle portion of the diaphragm is configured to contact the tube at normal operating pressures.

9. A tubular expansion tank, comprising:
a metallic pressure assembly, comprising:
first and second domes joined by a welded joint to form a chamber; and
a fitting attached to the first dome and adapted and constructed for connection to a plumbing system and providing fluidic communication between an interior and an exterior of the pressure assembly; and
a water chamber assembly, comprising:
a tube having first and second ends;
a cylindrical diaphragm disposed about the tube, wherein an interior of the diaphragm is in fluidic communication with an interior of the tube via at least one slot disposed at the first end of the tube and open to the first end of the tube; and
a collar providing fluidic communication between the fitting and the interior of the tube, wherein a first end of the diaphragm is sealingly affixed to a portion of the collar.

10. The tubular expansion tank of claim 9, further comprising a valve providing controllable fluidic communication between an exterior of the tank and a space between the metallic pressure assembly and the diaphragm, wherein the valve is disposed in a wall of one of the domes.

11. Cancelled

12. The tubular expansion tank of claim 9, wherein the first end of the tube has a plurality of slots.

13. The tubular expansion tank of claim 9, wherein the tank is adapted and constructed such that at least a middle portion of the diaphragm is configured to contact the tube at normal operating pressures.

14. A preassembled water chamber assembly for an expansion tank, comprising:
a tube having first and second ends;
a collar disposed at the first end of the tube;
a cap disposed at the second end of the tube; and
a resilient diaphragm having first and second ends, wherein the first end of the diaphragm is sealingly fitted about the collar and the second end of the diaphragm is sealingly fitted about the cap, wherein the first end of the tube has at least one slot providing fluidic communication between an interior of the tube and an interior of the diaphragm and wherein the slot is open to the first end of the tube.

15. Cancelled

16. The water chamber assembly of claim 14, wherein the first end of the tube has a plurality of slots.

17. The water chamber assembly of claim 14, wherein the collar comprises two portions having different exterior diameters, and wherein the exterior diameter of one of the portions is the same as the exterior diameter of the cap.

18. The water chamber assembly of claim 14, wherein the cap is sealingly attached to the second end of the tube.
